(19) United States
(12) Patent Application Publication
(10) Pub. No.: US 2003/0222450 A1
(43) Pub. Date: Dec. 4, 2003

(54) Accessory seat-belt buckle restraint

(76) Inventor: Lucille Sirois, Capreol (CA)

Correspondence Address: Mike M. Gauthier, 1264156 Ontario Incorporated, o/a Intel-Pro Design and Mfg., 959 Elisabella Street, Unit C, Sudbury, ON, P3A 5K1, CA

(21) Appl. No.: 10/155,077

(22) Filed: May 28, 2002

(51) Int. Cl. B60R 22/00

(52) U.S. Cl. 280/801.1

(57) ABSTRACT

An accessory device utilized to restrain access to a seat belt buckle, especially from children. The accessory device of the present invention comprises; a semi-rigid plastic shell having a front portion and a rear portion generally having a mirrored resemblance to each other, a hinge portion integrally attached to both front and rear portions so as to allow the joining of both front and rear portions thereby forming a shell-like casing surrounding the general area where a seat belt buckle may be located, a plurality of snap closures adapted to be relatively difficult for a child to separate yet separable by an adult thereby restraining access from a child to the containing buckle release button of a conventional seat belt.

### FIELD OF THE INVENTION

The present invention relates to an accessory device utilized to restrain access to a seat belt buckle, especially from children. The accessory device of the present invention comprises; a semi-rigid plastic shell having a front portion and a rear portion generally having a mirrored resemblance to each other, a hinge portion integrally attached to both front and rear portions so as to allow the joining of both front and rear portions thereby forming a shell-like casing surrounding the general area where a seat belt buckle may be located, a plurality of snap closures adapted to be relatively difficult for a child to separate yet separable by an adult thereby restraining access from a child to the containing buckle release button of a conventional seat belt.

### BACKGROUND OF THE INVENTION

Since the introduction of the automotive seat belt, there has been a growing concern with parents and drivers alike that children, especially under the age of six, from time to time, release their seat belt buckles, thereby exposing these children to grave dangers by not being properly restrained within the automobile. At times, when this occurs, a driver attempts to reach back and re-attach the seat belt while driving. It is obvious that this only adds to an already great danger which could cause injury or death.

It is desirable for drivers to have the peace of mind that once a seat belt is fastened onto a child, it will remain so. The present invention offers drivers such peace of mind as well as the ability to be universably adapted to function with any conventional seat belt buckle assembly. Furthermore, it is also desired to provide preferred orientational positioning of the upper diagonal of three belt assemblies.

The applicant is aware of several attempts in prior art to provide means of restraining access to a seat belt buckle. For example, reference may be had to U.S. Pat. No. 3,484,908 of Lamb, issued Dec. 23, 1969, which describes an accessory device adapted to slide over the buckle area and frictionally attach to said buckle thus preventing the wearer from releasing the buckle. However, this frictional engagement can easily be slid longitudinally away from the buckle thereby allowing access to said buckle. Furthermore, the device also fails to be universably adaptable to suit all conventional seat belt buckles. Additionally, this device fails to provide preferred orientational positioning of the upper diagonal of three belt assemblies.

Another example of prior art may be had in referring to U.S. Pat. No. 4,497,094 of Morris, issued Feb. 5, 1985, which depicts a child proof seat belt having a latch housing adapted to slide over a seat belt latch so as to disallow access to the latch release unless a small tool is used through an small opening adjacent to said latch release button. Although this invention may prove effective, it fails when a seat belt buckle has and end latch release as opposed to a face release. Furthermore, seat belt buckle vary greatly in shape, form and function thereby rendered useless with some buckle models. Additionally, this device also fails to provide preferred orientational positioning of the upper diagonal of three belt assemblies.

Another example of prior art may be had in referring to U.S. Pat. No. 4,675,954 of Gullickson, issued Jun. 30, 1987, which illustrates a flexible cover with sufficient rigidity that a child, as a rule, would not be able to activate a contained latch yet deflectable enough for an adult to succeed in said activation. This device also fails to be universably adaptable to suit all conventional seat belt buckles as it fails as well in providing preferred orientational positioning of the upper diagonal of three belt assemblies.

While many prior art inventions have succeeded in providing parents and drivers alike with safety covers for seat belt buckles, none offer the ability to be universably adapted to function with any conventional seat belt buckle assembly while also providing preferred orientational positioning of the upper diagonal of three belt assemblies.

### SUMMARY OF THE INVENTION

It is thus the object of the present invention to provide parents and drivers alike with a universably adapted safety cover for seat belt buckles that provides preferred orientational positioning of the upper diagonal of three belt assemblies.

In one aspect of the invention, the device may be fabricated with any suitable material with semi-rigid properties.

In another aspect of the invention, the device may be fabricated having only one belt sleeve as opposed to two.

Accordingly, the device of the present invention allows not only universably adaptable access-restraint to seat belt buckles, but also provides preferred orientational positioning of the upper diagonal of three belt assemblies.

### BRIEF DESCRIPTION OF THE DRAWINGS

These and other advantages of the invention will become apparent upon reading the following detailed description and upon referring to the drawings in which

FIG. 1 is a front elevation view of the accessory seat belt buckle restraint as in its proposed state of use.

FIG. 2 is a front elevation view of the accessory seat belt buckle restraint of the present invention.

FIG. 3 is a top plan view from above of the accessory seat belt buckle restraint of the present invention in its opened position shown with a conventional seat belt in its proposed position.

FIG. 4 is a right side elevation view of the accessory seat belt buckle restraint.

FIG. 5 is a left side elevation view of the accessory seat belt buckle restraint.

FIG. 6 is a cross-sectional view from FIG. 2 of the accessory seat belt buckle restraint of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

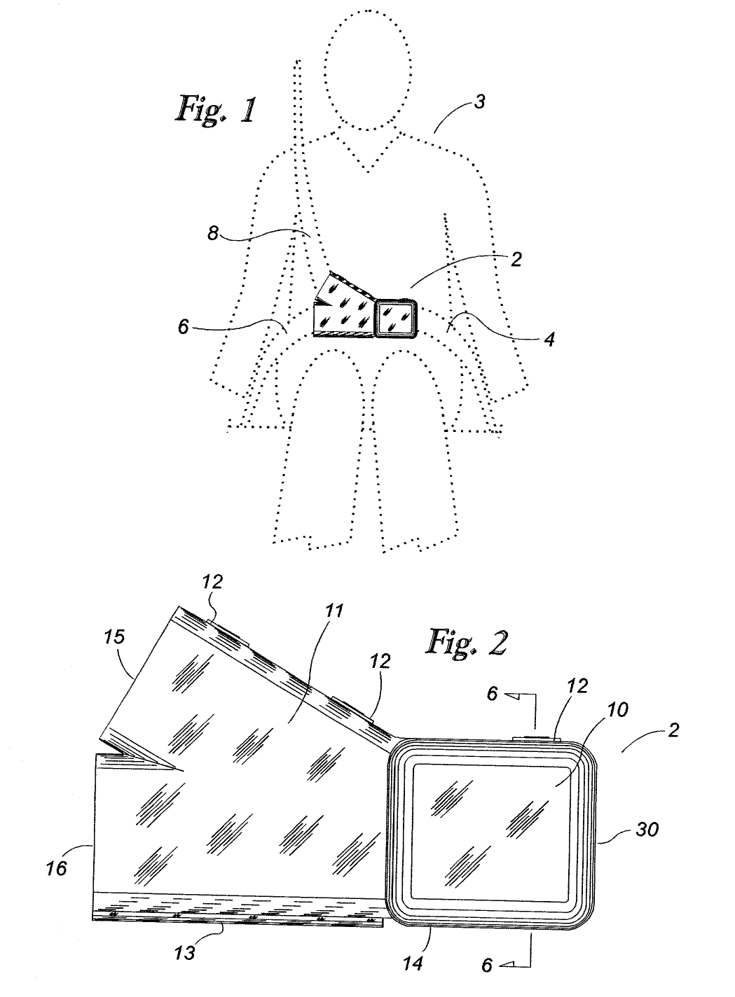

Turning to FIG. 1, which illustrates a front elevation view of the accessory seat-belt restraint device 2 as in use by a seated person 3. It can be noted that conventional seat belts comprise; a latch portion with a fixed length of belt material 4, and a clasp belt portion having a lower belt portion 6 fixedly attached to a structural member of a vehicle and an upper belt portion 8 adjustably attached to an upper structural member of a vehicle.

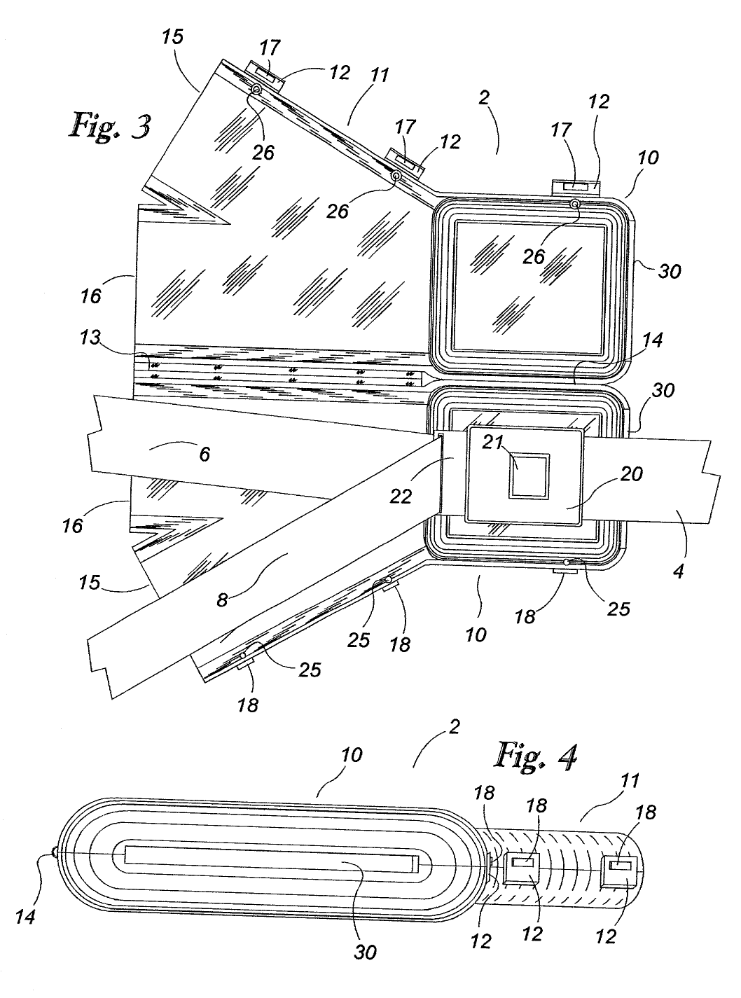

Now turning to FIG. 2, illustrating a front elevation view of the accessory seat-belt restraint device 2 of the present invention comprising; a buckle-latch portion 10, a clasp belt portion I 11, snap closures 12, and a hinge portion 13 and 14. The buckle-latch portion 10 having a molded body in the shape of a hollowed rectangular form with all edges rounded so as to have a smooth feel. While the manufactured form of the present invention is in its opened position as seen in FIG. 3, it is understood that when folded at the hinges 13 and 14, the joined halves form a hollowed units. Again in FIG. 2, the clasp belt portion 11 is formed in a generally “Y” shape so as to have one opening integrally connected to the buckle-latch portion 10 and two openings 15 and 16 distal from the buckle-latch portion 10. The plurality of snap closures 12 are adapted to releasibly attach the two halves together so as to firmly discourage access to the inner contained buckle portions.

Turning to FIG. 3, which illustrates a top plan view of the accessory seat-belt restraint device 2 as opened, illustrating the positioning of the conventional seat belt components. The two molded halves are integrally held together by way of thin bridges of material forming the hinge portion 13 and 14. When securing a child in a vehicle's seat, the adult would place the opened accessory device 2 behind the seat belt buckle assembly, latch the clasp 22 into the buckle 20 then fold the two halves together so that they enclose the seat belt assembly. As the halves join, a plurality of male guide pins 25 will mate with corresponding female receptacles 26 to provide greater stability and alignment to the snap closures 12. The adult must ensure that the buckle belt 4 is in the opening 30 of the buckle portion 10, and that the latch lap belt 6 is positioned in opening 16 of the latch belt portion 11 as well as the shoulder belt 8 need be positioned within opening 15 of the latch belt portion 11. Once joined, said closures 12, each having a perforation 17 of equal dimensions to that of the outer dimensions of the male catch 18 can be frictionally and releasibly attached by way of allowing the male catch to frictionally penetrate the perforation 17 of the closure 12.

Turning now to FIG. 4, depicting a right side elevation view of the accessory seat belt buckle restraint of the present invention wherein the snap closures 12 are more visible on the latch belts portion 11 of the present invention 2. This Figure is more intended to illustrate the opening 30 within the buckle portion 10 of the present invention 2, wherein said opening is larger than the profile of conventional seat belt material but smaller than any buckle assembly so as to disallow the passage of a buckle through said opening 30.

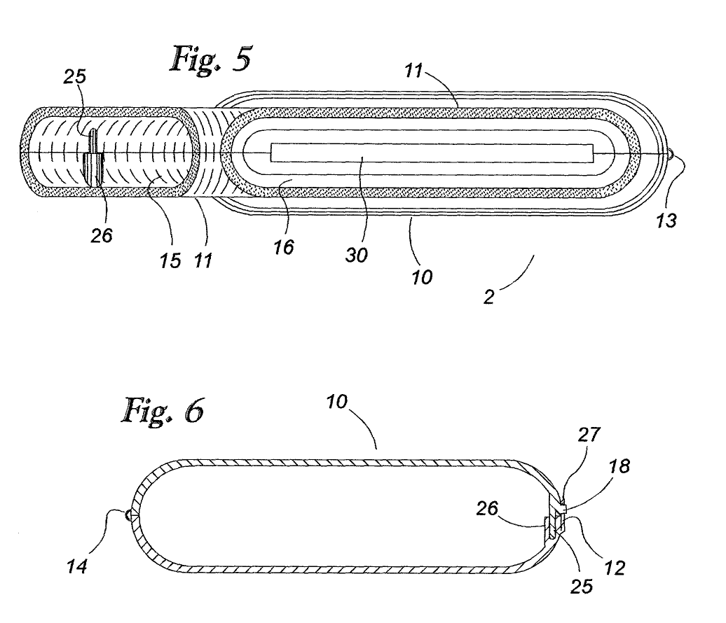

In reference now to FIG. 5, depicting a left elevation view of the accessory seat belt buckle restraint of the present invention 2 wherein the extremities of both openings 15 and 16 have been spotted to show the surfaces more accurately. Additionally, it can be noted that the opening 30 of the buckle portion 10, and openings 15 and 16 of the latch belt portion 11 are in unobstructed communication with each other.

FIG. 6, illustrates a cross sectional view from FIG. 2 of the accessory seat belt buckle restraint of the present invention 2 illustrating the joinery of both halves, more particularly the guide pin 25 with its mating female receptacle 26, and the snap closure 12 which is joined to the lower portion of the buckle portion 10 of the present invention.

The embodiments of the invention in which an exclusive property or privilege is claimed are defined as follows:—What I claim as my invention:—

1. An accessory seat belt buckle restraint comprising:
a semi-rigid plastic shell having a front portion and a rear portion generally having a mirrored resemblance to each other, a hinge portion integrally attached to both front and rear portions so as to allow the joining of both front and rear portions thereby forming a shell-like casing surrounding the general area where a seat belt buckle may be located, a plurality of snap closures adapted to be relatively difficult for a child to separate yet separable by an adult thereby restraining access from a child to the containing buckle release button of a conventional seat belt.

2. The accessory seat belt buckle restraint of claim 1 wherein the material of manufacture may be any suitable substitute with similar properties.
